(19) United States
(12) Patent Application Publication
(10) Pub. No.: US 2007/0175981 A1
(43) Pub. Date: Aug. 2, 2007

(54) Merchandise transaction system and data reading device thereof

(76) Inventors: Gigi Chen, Taipei (TW); Ko Li Chao, Taipei (TW); Kuo Sen Hsueh, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/410,112

(22) Filed: Apr. 25, 2006

(30) Foreign Application Priority Data
Jan. 27, 2006 (TW) 095103283

(51) Int. Cl. G06K 5/00; G06K 15/00

(52) U.S. Cl. 235/380; 235/383

(57) ABSTRACT

A merchandise transaction system and data reading device capable of gathering statistics of overall consuming detail data are provided. The data reading device comprises an input interface, a display interface, a data collecting processor, and a plurality of connecting ports. One end of each connecting port can electrically connect to the data collecting processor, and the other end thereof can selectively connect to a data reading module. When the consumer performs consuming transaction, the consumer can provide a plurality of identity identification elements to multiple certify to be benefit to complete the consuming behavior. The data collecting processor has a data storing interface for recording a single consuming detail data and sending it to a statistics unit which can collect every single consuming detail data to gather statistics, store, or analyze to obtain overall consuming detail data of the consumer. This way, not only can safety of the consumption be improved, but also usability of the consuming data can be raised.

### FIELD OF THE INVENTION

The present invention is related to a merchandise transaction system, and more particularly to a merchandise transaction system and data reading device capable of gathering statistics of overall consuming detail data, which not only improve the consumption security, but also raise of the consuming data usability.

### BACKGROUND

By the evolution of consuming behaviors, the consumption on the street stalls increasingly changes as well. Nowadays, people have been used to the shopping mode of performing consuming behaviors without carrying cash. In order to collocate such a plastic currency, it is an important issue to design a transaction certification device or data reading device which is reliable and suitable to the masses.

A prior art data reading device is shown in FIG. 1. The data reading device 11 mainly comprises a touch reading module 12, a card reading module 14, an input interface 13, and a display 15. In the process of performing the consuming transaction behavior, for example, checking out the consuming price, the sale end only needs at least one consuming card provided by the consumer, such as a credit card, cash card, or banking card. By the connecting and certifying of the touch reading module 12 or card reading module 14, collocating with an input password (not shown) of the input interface 13, the identity of the consumer can be confirmed to decide whether to accept the consumption of the consumer with the card.

Since the prior art data reading device 11 can only decide the identity of the consumer by the touch reading module 12, card reading module 14, or input interface 13, it is limited and inconvenient in use.

Further, the consuming card used in the prior art consuming mode or merchandise transaction system is easily recorded and stolen by the unworthy people using the data reading device 11 to get personal information to make false card to consume unsuitably to critically destroy the normal transaction market of the consuming cards. Therefore, the existed merchandise transaction system needs to be improved.

Further, the existed merchandise transaction system only has overall consuming detail data of the consumer in certain period of time gathered statistics by the financial unit. Although useful data, such as the consuming time, consuming store, and every consuming total price, is listed, the shopping merchandise detail data of every consumption cannot be seen. The collection of the consuming data is incomplete and cannot help the reference value, such as household accounting management of the consumer, supply location selection of the sale end, statistics of local consumption, or expanding business of financial industry.

Further, all elements and structure of the prior art data reading device use fixed type. The type of the data reading module has been fixed when designing the data reading device. After use, the data reading device cannot be quickly changed the data reading module type or increased data reading modules. This way, not only cannot the sale end select desired data reading module type according to real needs, but also the resources are easily wasted.

### SUMMARY OF THE INVENTION

Accordingly, how to design a merchandise transaction system and a data reading device thereof to be able to gather statistics of overall consuming detail data which can improve the safety and accuracy of the consumption by multiple certification, effectively raise the usability of the consuming data, and bring the best performance of the data reading device into full play with respect to the previous mentioned problems encountered by the prior art merchandise transaction system and data reading device is the key point of the present invention.

It is a primary object of the present invention to provide a merchandise transaction system having a data collecting processor in the data reading device of the sale end for recording single consuming detail data of the consumer. Every single consuming detail data can be sent to a statistics unit which can gather statistics, store, or analyze to obtain overall consuming detail data of the consumer and provide a reference to related units, such as users. This way, the usability of the consuming data can be effectively improved.

It is a secondary object of the present invention to provide a merchandise transaction system to quickly and accurately calculate overall consuming detail data of the consumer. It is convenient to the household accounting management of the consumer, and it is also benefit to the supply location selection of the sale end, statistics of local consumption, or expanding business of financial industry.

It is another object of the present invention to provide a data reading device having a plurality of data reading modules. By a plurality of various certifications, multiple consumer identity certification features are obtained to strengthen the safety and accuracy in consuming transaction to effectively reduce consuming disputes.

It is another object of the present invention to provide a data reading device whose various types of data reading modules can be removable by at least one connecting port to provide selectivity and extensibility of the sale end.

It is another object of the present invention to provide a data reading device whose data collecting processor can make various types of data reading modules communicate and collocate with each other. This way, points, price, added value, stored value, transferring, or data exchange between various types of identity feature elements can be performed without additionally connecting other financial units. It is benefit to smoothly proceeding the consuming behaviors, and it also helps the user to manage the assets.

To achieve the previous mentioned objects, the present invention provides a merchandise transaction system comprising: at least one data reading device having a data collecting processor, at least one data reading module, and a communication element, each data reading module and communication element electrically connected to the data collecting processor, the data reading module reading an identity identification element corresponding to a customer and generating a single consuming detail data under completing the transaction by the data collecting processor; and a statistics unit having a statistics database connected to the data reading device via the communication element for receiving the single consuming detail data, and generating a overall consuming detail data by gathering statistics and storing processes.

Further, to achieve the above mentioned objects, the present invention further provides a data reading device mainly comprising a case having an input interface and a display interface thereon, and having a data collecting processor, a communication element, and at least one data reading module therein, the communication element and data reading module electrically connecting to the data collecting processor, and an identity identification element from a consumer being read by the data reading module to thus generate a single consuming detail data which can be transmitted to a statistics unit by the communication element.

### BRIEF DESCRIPTION OF DRAWINGS

FIG. 1 is a structural diagram of a prior art data reading device.

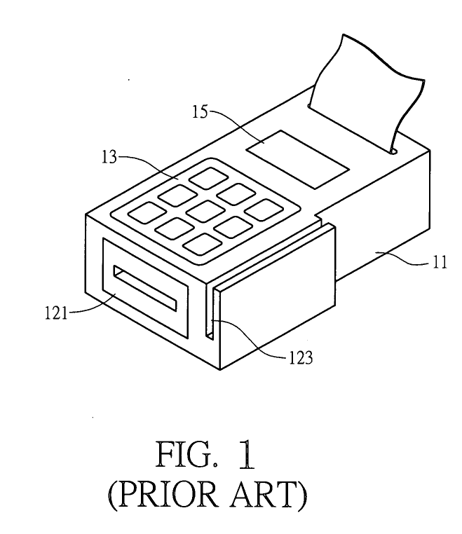

FIG. 2 is a structural diagram of a preferred embodiment of the present invention.

FIG. 3 is a structural diagram of another embodiment of the present invention.

FIG. 4 is a use diagram of the embodiment shown in FIG. 3 of the present invention.

### DETAILED DESCRIPTION

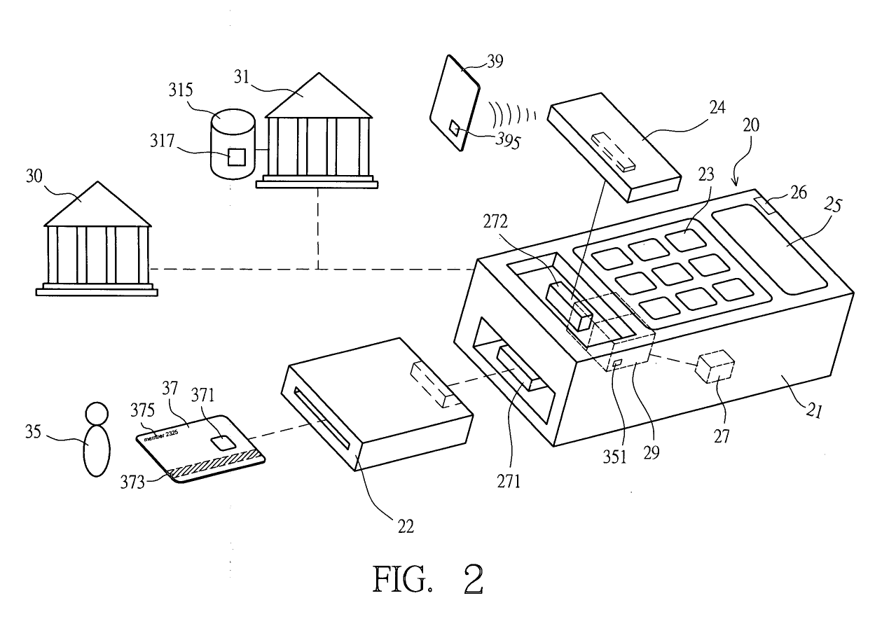

Firstly, refer to FIG. 2, a structural diagram of a preferred embodiment of the present invention. As shown, the consumer 35 can apply for at least one identity identification element, such as consuming card 37 or wireless sensing element 39 in this embodiment, to an issuing unit 30 which can be a government organization, financial organization, social group, company group, or store. The consuming card 37 can be a banking card, cash card, credit card, or member card. The consuming card 37 can have a chip 371, a magnetic bar 373, or a numeral, character, symbol 375, etc. The wireless sensing element 39 can be a card with a wireless radio frequency identification technology (RFID) function. The wireless sensing element 39 has a sensing label 395.

Generally, a store has a data reading device 20 mainly having an input interface 23, a display interface 25, and a plurality of connecting ports 271/272 on a case 21. Besides, in the case 21 has a data collecting processor 29 and a communication element 27.

The store can buy desired data reading module according to real needs, such as a touch reading module 22 or a wireless sensor reading module 24 as shown in this embodiment. The touch reading module 22 and wireless sensor reading module 24 in this embodiment are removable devices one end (back end) of which can removably directly connect to one of connecting ports 271/272 and electrically connect to the data collecting processor 29 such that the touch reading module 22 and wireless sensor reading module 24 can dispose on the case 22 to be constituted components of the data reading device 20.

When the consumer 35 performs a consuming transaction, checks out, and pays, the identity identification element issued by the issuing unit 30, such as the consuming card 37 or wireless sensing element 39, is provided to the store. Among them, the consuming card 37 can be put into the other end (front end) of the touch reading module 22. By the touch reading module 22, connecting port 271, data collecting processor 29, and communication element 27, the data in the consuming card 37 is connected to the issuing unit 30 to check the true identity of the consumer to complete deducting the consuming price and record the single consuming total price of the consumer and a sale end code or sale end 26 representing the store.

In order to repeatedly verify the identity of the consumer, the wireless sensor reading module 24 in the data reading device 20 of the present invention can also request to read another identity identification element of the consumer 35, such as wireless sensing element 39. Similarly, the data in the wireless sensing element 39 can be connected to the issuing unit 30 via the wireless sensor reading module 24, connecting port 272, data collecting processor 29, and communication element 27 to recheck the identity of the consumer. By collocating with the consuming card 37, it is achieved to repeatedly verify to reduce the risk of the consuming card being stolen.

Further, in various embodiments, the sensing label 395 of the wireless sensing element 39 is designed as various readable, writable, or readable/writable aspects to be used in identity identification and achieve an object of saving price.

Further, by the input interface 23, the consumer 35 can also input a set of passwords (not shown). By matching with the consuming card 37 and wireless sensing element 39, an object of repeatedly verifying consumer identity to improve the accuracy and safety of the transaction can be further achieved.

Of course, for the data reading device 20 of the present invention, if the consumer does not have the consuming 37, wireless sensing element 39, or type in the passwords to repeatedly verify identities, the data reading device 20 is a general prior art data reading device (11) which can still only read the data in the consuming card 37 or wireless sensing element 39.

Further more, when the data collecting processor 29 of the data reading device 20 of the present invention finishes consuming transaction, the single consuming detail data 351 of the consumer 35 can also be stored in the data collecting processor 29 or directly sent to a statistics unit 31 to save in the statistics database 315 of the statistics unit 31. Single consuming detail data 351, as general prior art bills, can record detailed data, such as shopping titles, amount, unit price, single merchandise total price, single consuming total price, date, store (sale end 26), of single consumption of the consumer 35.

The statistics 31 can collect, gather statistics, store, analyze, or record every single consuming detail data 351 to accordingly obtain an overall consuming detail data 317. The overall consuming detail data 317 can record consuming total price, issuing unit, consuming items, sale end (store) and single consuming detailed data 351 in some period of time of the consumer 35. Further, the above mentioned consuming items mean induced items after analyzing the consuming shopping merchandise, such as articles for daily use item, transportation item, entertainment item, food item, stationary item, book item, etc.

The overall consuming detail data 317 is provided as a reference to the consumer 35. The consumer 35 can clearly know consuming behaviors in a certain period of time to be benefit to household accounting management. It saves the trouble of registering consuming details of the household accounting everyday, and it can be a basis to view whether personal consuming behavior is correct.

The overall consuming detail data 317 is provided to the sale end, store, sale industry, or issuing unit. The consuming mode of each consumer can be analyzed, and it is also benefit to supply location selection of the sale end, local consumption statistics, expanding business of the financial industry.

Since the prior art issuing unit can only know partial data, such as consuming total price, date, and consuming location, of the consumer 35 in a certain time, but cannot know other data, such as consumed article category, unit price, or amount, of the consumer 35. Therefore, the overall consuming detail data 317 obtained by the merchandise transaction system of the present invention can integrate the prior art single consuming detail data 351 and partial data of each issuing unit 30 to have more data usability.

The above mentioned statistics unit 31 can be a government organization, financial organization, social group, company group, or store, even as the same organization as the issuing unit 30. Of course, after obtaining the agreement of the consumer 35, the single consuming detail data 351 of such a merchandise transaction system can be provided to the statistics unit 31, and the overall consuming detail data can be provided to related units.

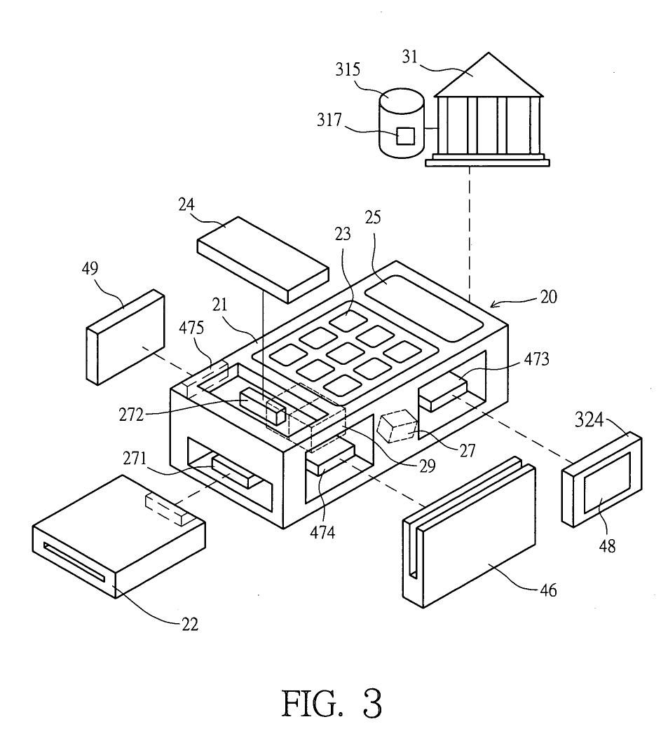

Moreover, please refer to FIG. 3, a structural diagram of another embodiment of the present invention. As shown, outside of the case 21 of the data reading device 20 can also selectively have other data reading modules, such as a card reading module 46, an optical reading module 48, or an organic feature sensing module 49. The card reading module 46, the optical reading module 48, and the feature sensing module 49 can also be a removable device and connected to the data collecting processor 29 by a connecting port 473/474/475 to provide more layers of consumer identity certification.

Further, in another embodiment of the present invention, the data reading module can also be fixed. In other words, the connecting port 271/272/473/474/475 can be discarded, and the touch reading module 22, wireless sensor reading module 24, card reading module 46, an optical reading module 48, or an organic feature sensing module 49 can be directly connected to the data collecting processor 29.

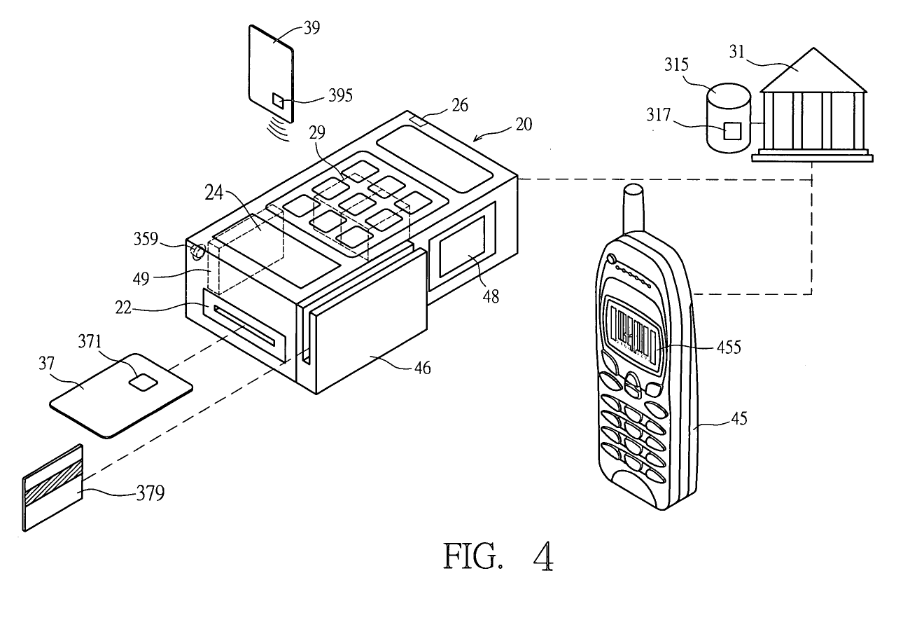

Finally, please refer to FIG. 4, a use diagram as shown in FIG. 3 of the present invention. As shown, the sale end assembles the data reading module in the data reading device according to real needs, such as one of the touch reading module 22, wireless sensor reading module 24, card reading module 46, optical reading module, organic feature sensing module 49, and a combination thereof.

Among them, the card reading module 46 can read a consuming card 379, such as data in the magnetic bar. The optical reading module 48 can read an electronic certificate 455 shown in a mobile device 45 of the consumer. The organic feature sensing module 49 can read at least one organic feature 359 of the consumer. The above mentioned consuming card 379, electronic certificate 455, and organic feature 359 are also identity identification elements of the consumer.

Further, the electronic certificate 455 can be selected as one of a barcode, multimedia message, text message, wireless network capturing message, symbol, and numeral. The organic feature 359 can be selected as one of a fingerprint, pupil, blood vessel, voice, symbol, numeral, character, and valid symbol. The mobile device 45 can be selected as one of a cell phone, portable computer, personal digital assistant, stock messenger, global satellite locator, video/audio player, and recording pen.

Further, the data collecting processor 29 can make an electric connection on data between removable data reading modules 22/24/46/48/49. Therefore, the data collecting processor 29 can also be a data transferring processor between each data reading module 22/24/46/48/49. By matching with each data reading module 22/24/46/48/49, various identity feature elements, such as consuming card 37, wireless sensing unit 39, mobile device 45, or electronic certificate 455, can transfer or exchange data in single data reading device 20 without additionally connecting to other issuing unit 30 or statistics unit 31 via the communication element 27, such as the points, price, added price, stored price, transferring, or data exchange of a wireless sensing unit 39 can be exchanged to another wireless sensing unit 39. Alternatively, the points, price, or data represented by an electronic certificate 455 is transferred to a wireless sensing unit 39 or a consuming card 38 (such as cash card). This way, it is not only benefit to smoothly proceed the consuming behavior, but also helpful for the asset management of the user. To this end, the data reading device 20 or data collecting processor 29 can be a data exchange platform between the data reading modules 22/24/46/48/49 or each identity feature element 37/39/45/455/359.

That is to say, when the wireless sensing element 39 and consuming 39 use the device of the present invention at the same time, the consuming card 37 can save value to the wireless sensing element 39 by the data collecting processor 29 without cash to achieve an object of saving value.

Since the data reading modules 22/24/46/48/49 of the present invention can be quickly assembled in the data reading device 20 by the connecting ports 271/272/473/474/475. Therefore, the data reading device 20 can have most performance to relatively save the resource from wasting.

The foregoing description is merely one embodiment of present invention and not considered as restrictive. All equivalent variations and modifications in process, method, feature, and spirit in accordance with the appended claims may be made without in any way from the scope of the invention.

### LIST OF REFERENCE SYMBOLS

11 data reading device
12 touch reading module
13 input interface
14 card reading module
15 display
20 data reading device
21 case
22 touch reading module
23 input interface
24 wireless sensor reading module
25 display interface
26 sale end code
27 communication element
271 connecting port
272 connecting port
29 data collecting processor
30 issuing unit
31 statistics unit
315 statistics database
317 overall consuming detail data
35 consumer
351 single consuming detail data
359 organic feature
37 consuming card
371 chip
373 magnetic bar
375 symbol
379 consuming card
39 wireless sensing element
395 sensing label
45 mobile device
455 electronic certificate
46 card reading module
473 connecting port
474 connecting port
475 connecting port
48 optical reading module
49 organic feature sensing module

1. A merchandise transaction system mainly comprising: at least one data reading device comprising a data collecting processor, at least one data reading module, and a communication element, each data reading module and communication element electrically connected to said data collecting processor, said data reading module reading an identity identification element corresponding to a customer and generating a single consuming detail data under completing said transaction by said data collecting processor; and a statistics unit comprising a statistics database connected to said data reading device via said communication element forreceiving said single consuming detail data, and generating a overall consuming detail data by gathering statistics and storing processes.

2. The merchandise transaction system according to claim 1, wherein said single consuming detail data can selectively comprise one of a shopping title, amount, unit price, total price, date, sale end, and a combination thereof, and said overall consuming detail data can selectively comprise one of a consuming total price, issuing unit, consuming item, shopping title, amount unit price, total price of single merchandise, single consuming total prices, data, sale end, and a combination thereof.

3. The merchandise transaction system according to claim 1, wherein said data reading module can selectively comprise one of a touch reading module, a wireless sensor reading module, a card reading module, an optical reading module, an organic feature reading module, and a combination thereof.

4. The merchandise transaction system according to claim 1, wherein said identity feature element can be applied the consumer from an issuing unit, and said identity feature element can selectively be one of a consuming card, a wireless sensing element, an electronic certificate, an organic feature, a password, and a combination thereof.

5. The merchandise transaction system according to claim 4, wherein said identity feature element can also perform data exchange by said data collecting processor.

6. The merchandise transaction system according to claim 4, wherein said issuing unit and said statistics unit are within the same unit.

7. The merchandise transaction system according to claim 1, wherein said statistics unit can be selected as a government organization, financial institution, social group, company group, store, and a combination thereof.

8. The merchandise transaction system according to claim 3, wherein said touch reading module can read a consuming card of said consumer, and said consuming card can be selected as a credit card, banking card, cash card, member card, and a combination thereof.

9. The merchandise transaction system according to claim 3, wherein said wireless sensor reading module can read a wireless sensing element of the consumer.

10. The merchandise transaction system according to claim 3, wherein said optical reading module can read one of electronic certificates from the consumer, and said electronic certificate can be within one of mobile devices from the consumer.

11. The merchandise transaction system according to claim 3, wherein said organic reading module can read an organic feature of the consumer, and said organic feature can selectively comprise a fingerprint, pupil, blood vessel, voice, symbol, numeral, character, valid symbol, and a combination thereof.

12. The merchandise transaction system according to claim 1, wherein said data reading device further comprises at least one connecting port one end of which can connect to said data collecting processor and the other end of which can connect to said data reading module.

13. The merchandise transaction system according to claim 11, wherein said data reading module can be a removable device.

14. The merchandise transaction system according to claim 1, wherein said data reading device further comprises a display interface and an input interface.

15. The merchandise transaction system according to claim 1, wherein said single consuming detail data can be transmitted to said statistics unit after obtaining the agreement from the consumer.

16. A data reading device comprising a case having an input interface and a display interface thereon and having a data collecting processor, a communication element, and at least one data reading module therein, said communication element and data reading module electrically connecting to said data collecting processor, and an identity identification element from a consumer being read by said data reading module to thus generate a single consuming detail data which can be transmitted to a statistics unit by said communication element.

17. The data reading device according to claim 16 further comprising at least one connecting port one end of which connects to said data collecting processor and the other end of which connects to said data reading module.

18. The data reading device according to claim 17, wherein said data reading module can be a removable device.

19. The data reading device according to claim 16, wherein said data reading module can selectively comprise one of a touch reading module, a wireless sensor reading module, a card reading module, an optical reading module, an organic feature reading module, and a combination thereof.

20. The data reading device according to claim 16, wherein said statistics unit can be selected as a government organization, financial institution, social group, company group, store, and a combination thereof.

21. The data reading device according to claim 16, wherein said touch reading module can read a consuming card of the consumer, and said consuming card can be selected as a credit card, banking card, cash card, member card, and a combination thereof.

22. The data reading device according to claim 19, wherein said wireless sensor reading module can read a wireless sensing element from the consumer.

23. The data reading device according to claim 19, wherein said optical reading module can read an electronic certificate of the consumer, and said electronic certificate can exist in a mobile device from the consumer.

24. The data reading device according to claim 19, wherein said organic reading module can read an organic feature of the consumer, and said organic feature can selectively comprise a fingerprint, pupil, blood vessel, voice, symbol, numeral, character, valid symbol, and a combination thereof.

25. A data reading device mainly comprising a case having an input interface and a display interface thereon, and having a data collecting processor, a communication element, at least one connecting port, and at least one data reading module therein, said communication element and data reading module electrically connecting to said data collecting processor, one end of said connecting port connecting to a data reading module with a removable characteristic, and said data reading module reading an identity element from a consumer.

26. The data reading device according to claim 25, wherein said data reading module can selectively comprise one of a touch reading module, a wireless sensor reading module, a card reading module, an optical reading module, an organic feature reading module, and a combination thereof.
